(19) United States
(12) Patent Application Publication
(10) Pub. No.: US 2014/0037909 A1
(43) Pub. Date: Feb. 6, 2014

(54) Actuation and Control of Stamp Deformation in Microcontact Printing

(71) Applicant: Massachusetts Institute of Technology, Cambridge, MA (US)

(72) Inventors: Muhammad A. Hawwa, Dhahran (SA); Hussain Al-Qahtani, Dhahran (SA); Hassen Ouakad, Dhahran (SA); David E. Hardt, Cambridge, MA (US); Joseph Edward Petrzelka, Cambridge, MA (US); Brian Anthony, Cambridge, MA (US)

(21) Appl. No.: 13/956,702

(22) Filed: Aug. 1, 2013

Related U.S. Application Data
(60) Provisional application No. 61/678,274, filed on Aug. 1, 2012.

(51) Int. Cl. G01L 9/00

(52) U.S. Cl. CPC G01L 9/0072
USPC 428/172; 428/523; 428/447; 264/104

(57) ABSTRACT

A practical implementation of a flexible and transparent capacitive sensor is disclosed. The results show that, while PDMS is an inherently nonlinear material, linear behavior with minimal hysteresis can be obtained over an appropriately small range of operation. Moreover, high resolution has been achieved during these tests.

### CLAIM OF PRIORITY

This application claims the benefit of prior U.S. Provisional Application No. 61/678,274, filed on Aug. 1, 2012, which is incorporated by reference in its entirety.

### TECHNICAL FIELD

The present invention relates to flexible pressure transducers.

### BACKGROUND

Flexible pressure sensors from soft materials (e.g. low modulus elastomers) have traditionally been developed for biometric research applications or new types of robotics and interfacial sensors. Flexible pressure transducers have been developed using both resistive and capacitive technology that convert an applied force to an electrical signal using the mechanistic behavior of the elastomeric body. See, Someya T, Sekitani T, Iba S, Kato Y, Kawaguchi H, Sakurai T. A large-area, flexible pressure sensor matrix with organic field-effect transistors for artificial skin applications. Proc Nat Acad Science. 2004;101(27):9966-9970, Wang L, Ding T, Wang P. Thin flexible pressure sensor array based on carbon black/silicone rubber nanocomposite. IEEE Sensors Journal. 2009;9(9):1130-5, Park Y L, Majidi C, Kramer R, Brard P, Wood R J. Hyperelastic pressure sensing with a liquid-embedded elastomer. Journal of Micromechanics and Microengineering. 2010;20(12):125029, Metzger C, Fleisch E, Meyer J, Dansachm\ddot{} uller M, Graz I, Kaltenbrunner M, et al. Flexible-foam-based capacitive sensor arrays for object detection at low cost. Applied Physics Letters. 2008;92(1):013506, and Mannsfeld S C B, Tee B C K, Stoltenberg R M, Chen C V H H, Barman S, Muir B V O, et al. Highly sensitive flexible pressure sensors with microstructured rubber dielectric layers. Nature Materials. 2010;9(10):859-64, each of which is incorporated by reference in its entirety.

A flexible pressure sensor can be used in a roll mounted configuration for in-situ pressure sensing of a roll to roll printing process, for example microcontact printing or nanoimprint lithography (both of which have high sensitivity to contact pressure). A capacitive design wherein small elastomeric microfeatures on a stamp are able to deform under pressure σ is adopted. This deformation alters the distance between an external ground plane and an encapsulated conductor in the elastomeric stamp.

### SUMMARY

A flexible capacitive pressure transducer can include a device including a first elastomeric polymer layer, a conductive layer having a surface in contact with the first elastomeric polymer layer, and a second elastomeric polymer layer adjacent to the conductive layer and opposite the first elastomeric polymer layer. The conductive layer can include conductive polymer, and one elastomeric polymer layer can include a micropatterned surface. The elastomeric polymer can include a siloxane. A pressure transducer can include the device and a second conductive layer where the first elastomeric layer is in contact with the second conductive layer.

A method of manufacturing a device can include applying a first elastomeric polymer layer on a substrate, applying a conductive layer on top of the first elastomeric polymer, applying a second elastomeric polymer layer on top of the conductive layer such that the conductive layer has a surface in contact with the first elastomeric polymer layer and the second elastomeric polymer layer adjacent to the conductive layer and opposite the first elastomeric polymer layer, and removing the first elastomeric polymer layer, the conductive polymer layer and the second elastomeric polymer layer together from the substrate. The elastomeric polymer in the device can be a silicone. The method of manufacturing a device can further include preparing the substrate including a micropattern.

Other aspects, embodiments, and features will be apparent from the following description, the drawings, and the claims.

### BRIEF DESCRIPTION OF THE DRAWINGS

FIGS. 1A and 1B are schematics depicting a flexible capacitive pressure transducer.

FIGS. 2A-2D are schematics depicting steps to produce a flexible, transparent, microstructured stamp with an encapsulated conductor.

FIGS. 3A and 3B are photographs depicting typical results of this fabrication process.

FIG. 4A is a schematic of characterization of a device. FIG. 4B is a photograph of a prepared 2 cm×2 cm experimental sample shown with the active capacitive area outlined.

FIG. 5 is a graph depicting a power spectral density of sensor noise

FIG. 6 is a graph depicting a typical impulse response obtained by striking the sensor.

FIGS. 7A-7B are graphs depicting a small displacement sensor behavior at different loading rates.

FIGS. 8A-8B are graphs depicting a large deformation sensor behavior.

### DETAILED DESCRIPTION

A capacitive pressure sensor can sense pressure changes using a diaphragm and pressure cavity to create a variable capacitor to detect strain due to applied pressure. Common technologies use metal, ceramic, and silicon diaphragms. Generally, these technologies are most applied to low pressures. The applications of a large area, flexible pressure sensor includes electronic skin that emulates the properties of natural skin or future robots used by humans in daily life for housekeeping and entertainment purposes. Therefore, it is especially important to develop a technology for producing pressure-sensitive pixels with sufficient sensitivity in both medium- (10-100 kPa, suitable for object manipulation) and low-pressure regimes (<10 kPa, comparable to gentle touch). The conventional silicon meta-oxide semiconductor field-effect transistor technology cannot reliably sense low pressure values (<10 kPa) owing to its very large thermal signal shift of ˜4 kPa/K.

A flexible capacitive pressure transducer disclosed herein uses the load-displacement behavior of elastomeric microfeatures that alters capacitance through changes in the gap in a parallel plate capacitor. A pressure sensor system can include an array of capacitors made with the coupling capacitance between two conductive layers separated by an elastomeric and dielectric material that has a dielectric constant sufficient to create a measurable capacitance between the two conductive electrodes. The sensing array results from the crossing of these conductive threads patterned in rows and columns of a matrix. When the dielectric layer between a given row and column of electrodes is squeezed, as pressure is exerted over the corresponding area, the coupling capacitance between the two is increased. By scanning each column and row, the image of the pressure field can be obtained.

The elastomeric material can include a silicone elasomer, a polyurethane elastomer, a polyester elastomer, a polyamide elastomer, a polyethylene-poly(-olefin), a polypropylene/poly(ethylene-propylene), a poly(etherimide)-polysiloxane, apolyprolylene/hydrocarbon rubber, a polypropylene/nitrile rubber, a PVC-(nitrile rubber+DOP), a polypropylene/poly(butylacrylate), a polyamide or polyester/silicone rubber.

The layer can cover 80% of the surface of an adjacent layer or more. In embodiments, the layer cover at least 85%, 90% or 95% of the surface between the electrodes of the device. The thickness of elastomeric material can be less than 100 μm, less than 90 μm, less than 80 μm, less than 70 μm, less than 60 μm, less than 50 μm, less than 40 μm, less than 30 μm, less than 20 μm, less than 10 μm, or less than 5 μm.

As used herein “micropattern” refers to an arrangement of dots, traces, filled shapes, or a combination thereof, each having a dimension (e.g. trace width) of no greater than 1 mm. In preferred embodiments, the micropattern is a mesh formed by a plurality of traces defining a plurality of patterned features, each trace having a width of at least 0.1 micron and typically no greater than 20 microns. The dimension of the micropattern features can vary depending on the micropattern selection. In some favored embodiments, the micropattern feature dimension is less than 10, 9, 8, 7, 6, or 5 micrometers (e.g. 1 to 3 micrometers). The patterned features can have a dimension in the range of 0.1 to 20 micrometers, in some embodiments in the range of 0.5 to 10 micrometers, in some embodiments in the range of 0.5 to 5 micrometers, in some embodiments in the range of 0.5 to 4 micrometers, in some embodiments in the range of 0.5 to 3 micrometers, in some embodiments in the range of 0.5 to 2 micrometers, in some embodiments from 1 to 3 micrometers, in some embodiments in the range of 0.1 to 0.5 micrometer. Linear or non-linear patterned features can be useful in the design of the device.

The device can be a microcontact printing stamp, or a portion thereof, a pressure transducer, or portion thereof, or other touch sensitive component.

Previously indium tin oxide coated PET (polyethylene terephthalate) backplane and tapered (i.e. triangular or pyramidal, as opposed to prismatic) has been described (Mannsfeld S C B, Tee B C K, Stoltenberg R M, Chen C V H H, Barman S, Muir B V O, et al. Highly sensitive flexible pressure sensors with microstructured rubber dielectric layers. Nature Materials. 2010;9(10):859-64, which is incorporated by reference in its entirety). Disclosed herein is a flexible pressure transducer inspired by elastomeric stamps used in soft lithography similar in operation to that reported by Mannsfeld. A flexible capacitive pressure transducer uses the load-displacement behavior of elastomeric microfeatures to alter the gap in a parallel plate capacitor. The key to this technique is the ability to produce a microfeatured elastomeric stamp with an encapsulated conductive layer, which permits more deformation than indium tin oxide, which is notoriously brittle and ill-suited for flexible electronics. Moreover, the use of triangular features creates a changing contact area during sensor compression, which results in slower sensor performance and more significant hysteresis. For example, the results of Mannsfeld show a settling time of about 1 s after removal of load from the sensor, while the results highlighted herein shows a settling time of about 50 ms from an impulse response.

A possible industrial application of flexible pressure transducers is in roll based lithography. Studies have shown that processes like nanoimprint lithography (see, for example, Ahn S H, Guo L J. Large-area roll-to-roll and roll-to-plate nanoimprint lithography: a step toward high-throughput application of continuous nanoimprinting. ACS Nano. 2009;3(8):2304-2310. which is incorporated by reference in its entirety) and microcontact printing (see, for example, Petrzelka J E, Hardt D E. Roll based soft lithography: stamp contact mechanics and process sensitivity. ASME Journal of Manufacturing Science and Technology (submitted) which is incorporated by reference in its entirety) are sensitive to the contact pressure distribution between the substrate and the patterned printing roll. A flexible pressure transducer can be incorporated into either the tool (in the case of microcontact printing) or a backup roll (in the case of nanoimprint lithography) to provide an in situ measurement of contact pressure. This approach would enable both process monitoring and process feedback control.

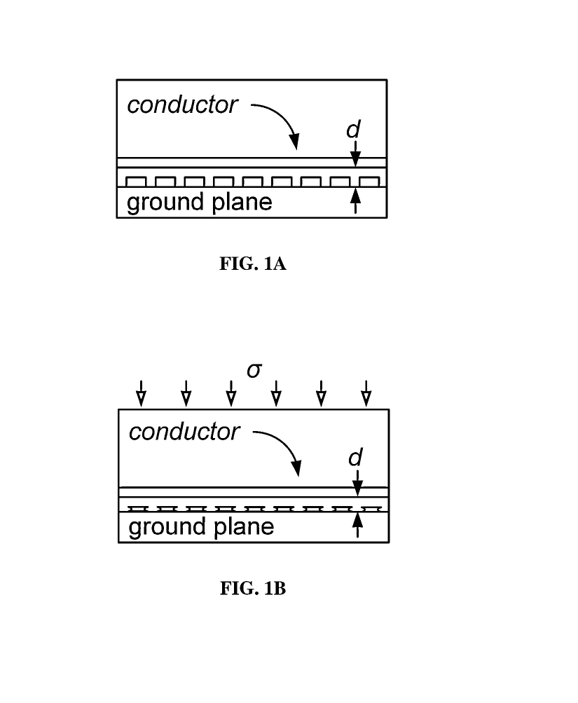

In the disclosed device, a conductive plane is formed within an elastomeric stamp that contains a series of patterned microfeatures (FIG. 1). As pressure is applied between the flexible transducer and a rigid ground plane, the patterned features elastically deform to reduce the height of the conductive stamp plane. The capacitance between the stamp conductive plane and the rigid ground plane can be measured to determine the pressure and displacement imposed on the features. This device has the potential for high resolution measurement of local contact pressures. FIG. 1A shows that a pressure transducer is formed by incorporating a conductive plane in an elastomeric stamp with microfeatures that can be placed on a ground plane. When an external pressure is applied, the features elastically deform to alter the capacitive gap d between the stamp conductor and ground plane (FIG. 1B).

### Theory of Operation

Capacitance is a displacement-dependent property in this deformable sensor. Transduction in this sensor is thus dependent on the mechanical load-displacement behavior of the microfeatures.

The capacitance between the conductor and ground plane is given by

$$C = \frac{ε A}{d}$$

Where ε is the dielectric constant of the gap material (e.g. polydimethylsiloxane (PDMS)), A is the area of the parallel plates, and d is the plate spacing, here a function of the external pressure σ and the load-displacement behavior of the microfeatures.

Small static deformation of PDMS microfeatures is well understood from applications like soft lithography. See Petrzelka J E, Hardt D E. Static load-displacement behavior of PDMS micro-features for soft lithography. Journal of Micromechanics and Microengineering. 2012;22(7):075015, which is incorporated by reference in its entirety. In a precision sensor application, two additional phenomena are important: nonlinear large deformation behavior and time dependent viscoelastic behavior.

While elastomeric microfeatures deform linearly at small displacements, large displacements lead to nonlinear behavior from large deformation kinematics and strain stiffening behavior (i.e. polymer chain locking). These effects combine to produce an inherently nonlinear kinematic relationship between stress and deformation (and hence capacitance).

Elastomers are viscoelastic materials, where both creep and stress relaxation must be considered. At short timescales, creep acts to dampen material deformation, similar to a single pole system that limits ultimate sensor bandwidth. At longer timescales, stress relaxation limits the achievable sensor accuracy.

### Device Fabrication

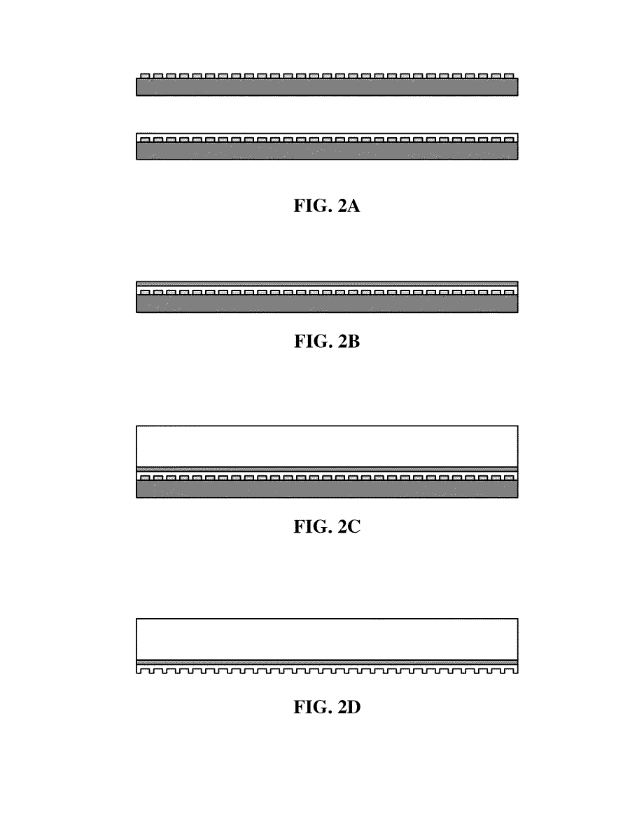

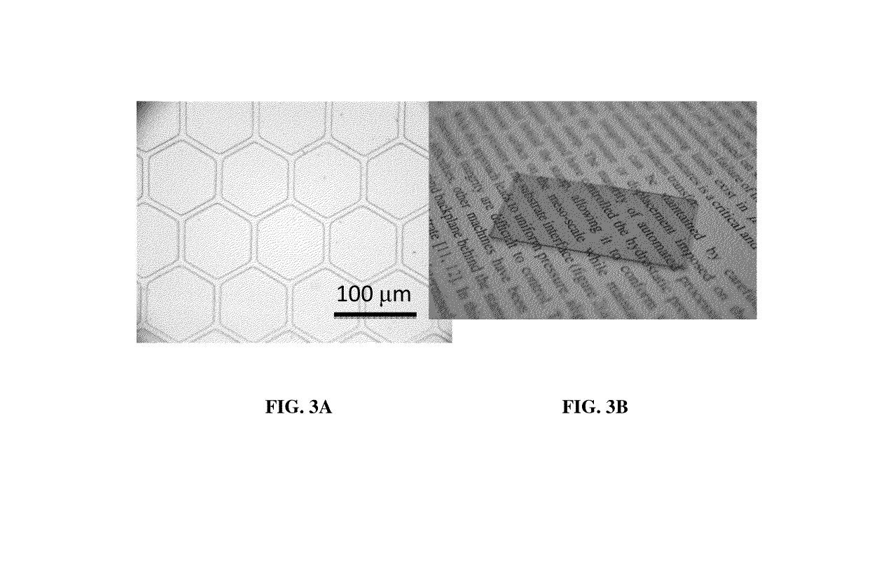

The flexible pressure transducer with an encapsulated conductor was fabricated using microfabrication techniques as illustrated in FIGS. 2A-2D. A 100 mm silicon wafer was patterned with SU8 2005 (Microchem) to produce a hexagonal pattern of 5 μm wide lines that were 3 μm tall (FIG. 2A). The patterned wafer was treated with hexamethyldisilazane to prevent adhesion of the subsequent polymer layers. PDMS (Dow Corning Sylgard 184) was applied to the wafer, degassed in a vacuum desiccator, and thinned by spin coating to produce a uniform, thin coat of PDMS (FIG. 2A). The wafer is spun at 6000 rpm for 30 s to 5 min, resulting in a final thickness of 10 to 5 microns (respectively). The PDMS is thermally cured on a hotplate. After curing the PDMS, a layer of conductive polymer (PEDOT:PSS, Heraeus Clevios S V3 HV) was applied by spin coating at 3000 rpm for 30 s and annealed (FIG. 2B). Finally, a thick layer of PDMS was cast against the wafer by injection molding (FIG. 2C). Removing the three polymer layers from the patterned wafer produced a thin, flexible microfeatured PDMS slab with an encapsulated layer of conductive polymer (FIG. 2D). FIG. 3 is photographs depicting typical results of this fabrication process. The pattern of sparse 5 um wide lines was produced on surface of elastomeric stamp. A sample of the final three layer stamp shows transparency.

The conductive polymer can alternatively be screen printed on the stamp to produce a patterned conductive layer, or patterned using photolithographic means, for example a shadow mask combined with polymer vapor deposition. The first layer of PDMS can be thinned with a solvent, for example hexane, to produce a thinner layer of microfeatured PDMS to increase capacitance.

### Experimental Characterization

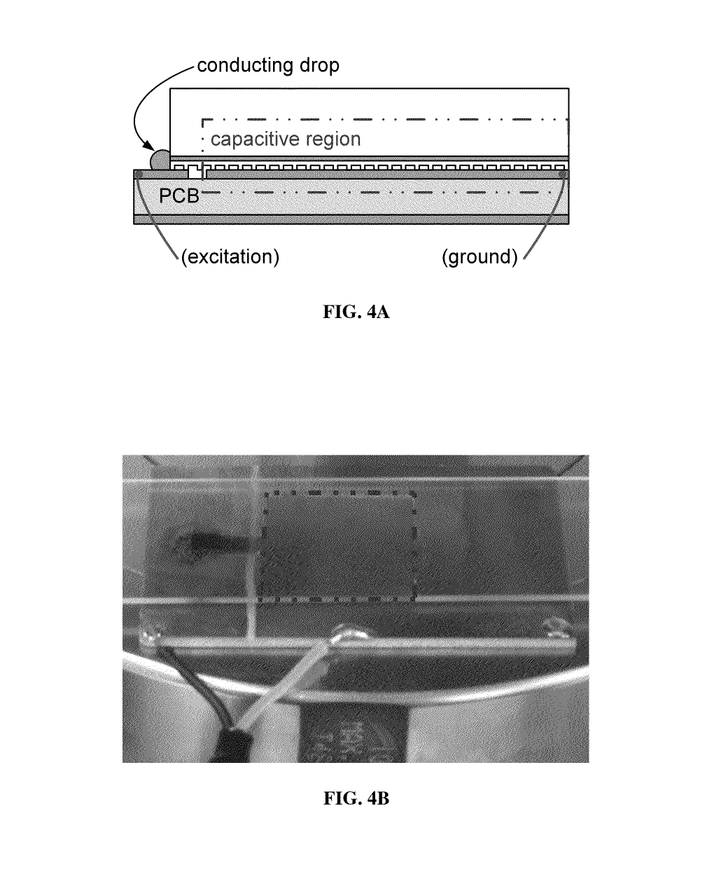

Experiments were conducted by mounting a 20 mm square sample (400 mm area) of the flexible sensor against a printed circuit board (PCB) and cycling the construct in a load frame. Electrical connection was made between the PCB and encapsulated conductive layer in the stamp using a droplet of liquid PEDOT:PSS solution (FIG. 4). Note that in an alternate embodiment, the sensor can be laminated against another flexible layer with conductors to produce a full capacitor with entirely flexible or transparent materials.

The sensor capacitance (CO=2 nF) was measured using an resistor-capacitor (RC) low pass circuit. The circuit output was measured with a RMS to DC converter and recorded with a National Instruments PCI-6220 data acquisition card with a 1 kHz hardware antialiasing filter.

### Results

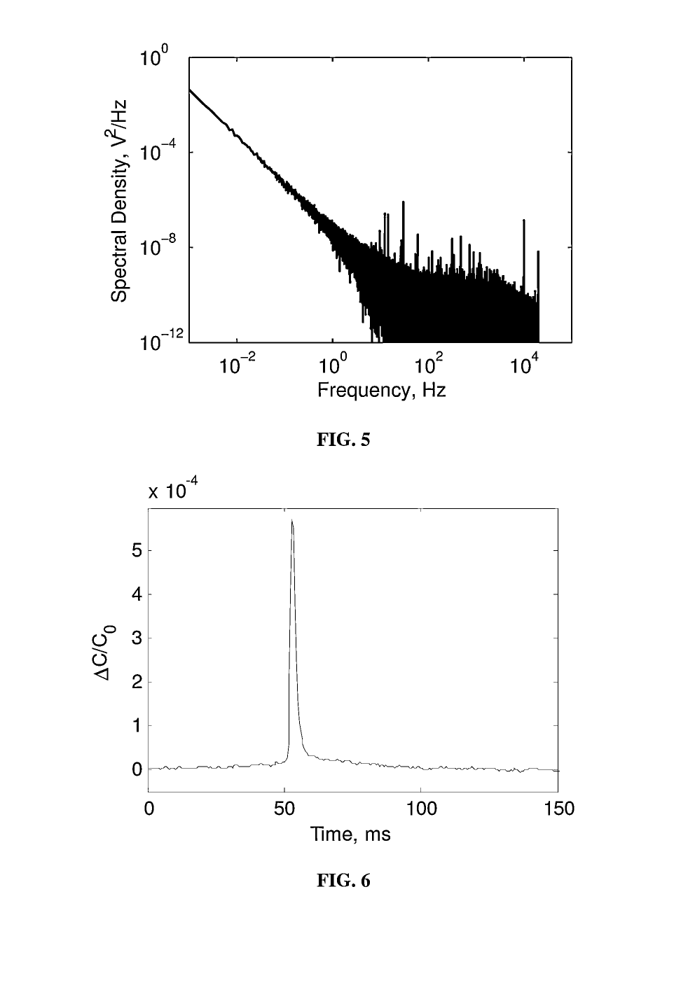

The sensor noise was analyzed using 1000 s of data recorded at a 40 kHz sampling rate. The resulting power spectral density (PSD) is shown in FIG. 5. These data show that the sensor has a resolution (above 1 Hz) of 400 μV (25 Pa) and an accuracy (below 1 Hz) of 8.6 mV (500 Pa). The sensor tested has a useful output range of about 0.5V/10V, giving a sensor dynamic range of 62 dB. Note intersection of Johnson and flicker noise at 10 Hz/10 V²/Hz and roll off at 1 kHz from a hardware antialiasing filter.

FIG. 2 shows a graph depicting a typical impulse response obtained by striking the sensor. This impulse response shows about a 16 ms time constant during the decay, corresponding to a 10 Hz sensor bandwidth. The short settling time of about 50 ms suggests an achievable sensor bandwith of at least 10 Hz. This fast response is obtained by using prismatic stamp features with a fixed contact area.

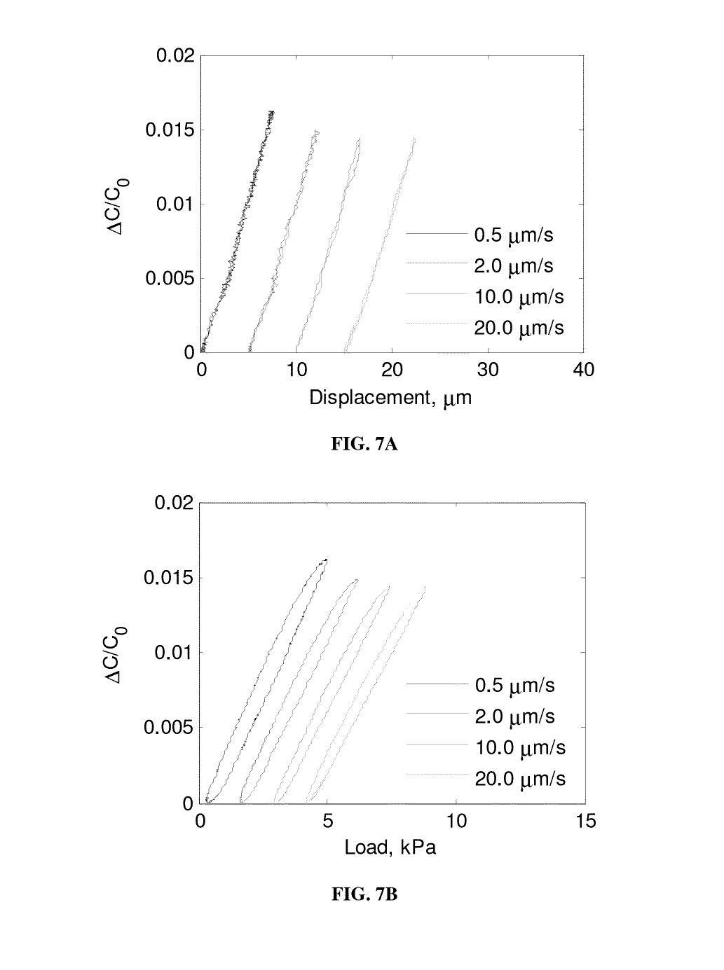

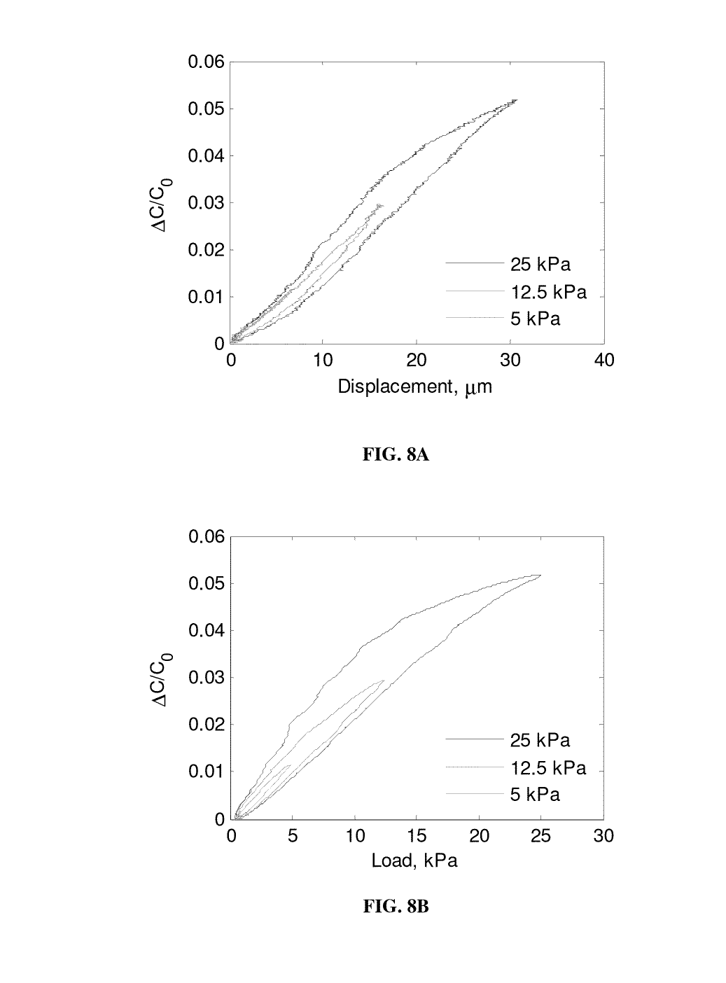

The linearity and hysteresis of the sensor were characterized through cyclic loading at different strain rates and load maxima. Small and large displacement behavior was investigated independently (FIGS. 7 and 8). The small displacement behavior shows excellent linearity between the displacement and capacitance behavior, but discernible hysteresis (about 10%) in the load-capacitance relationship. This hysteresis does not seem to be significantly influenced by strain rate, suggesting nonlinear effects.

FIG. 7 shows a small displacement sensor behavior at different loading rates. Despite more than an order of magnitude difference in strain rate, no discernable difference is evident in the sensor hysteresis. The load-capacitance behavior has linearity (including effects of hysteresis) of 9.6%, 7.4%, 6.8%, and 6.8% (0.5, 2.0, 10.0, and 20.0 um/s respectively). The large deformation behavior shows a combination of nonlinear kinematics and increased hysteresis. The hysteresis becomes as large as 20% for loads near the collapse pressures of the microfeatures.

FIG. 8 depicts a large deformation sensor behavior showing nonlinearity and increased hysteresis. The load-capacitance behavior has a linearity (including hysteresis) of 9.0%, 12.5%, and 20.2% (5 kPa, 12.5 kPa, and 25 kPa, respectively).

These experimental results highlight characteristics of elastomeric pressure tranducers that must be considered during system design. With refinement this technique can produce sensors with ΔC/C of 1 and resolution on the order of 1 Pa, while having improved bandwidth and manufacturability compared to other flexible sensor designs. While the sensors can achieve adequate resolution and dynamic range, their accuracy is limited by effects of stress relaxation and hysteresis. Material damping may limit accuracy at bandwidths above about 10 Hz.

Despite these limitations, the sensor system with an elastomeric layer with a pattern shows surprising characteristics that can be deployed in an industrial setting like in situ pressure sensing in roll to roll printing. A complete dynamic model of sensor performance, coupled with the inherently cyclic nature of roll based processing, should result in sufficiently accurate sensor performance. In particular, the device having a micropatterned elastomeric layer has a surprisingly useful pressure response curve.

Other embodiments are within the scope of the following claims.

What is claimed is:

1. A device comprising:
a first elastomeric polymer layer;
a conductive layer having a surface in contact with the first elastomeric polymer layer; and
a second elastomeric polymer layer adjacent to the conductive layer and opposite the first elastomeric polymer layer.

2. The device of claim 1, wherein the conductive layer includes a conductive polymer.

3. The device of claim 1, wherein one elastomeric polymer layer includes a micropatterned surface.

4. The device of claim 1, wherein the elastomeric polymer includes a siloxane.

5. A pressure transducer comprising:
the device of claim 1;
and a second conductive layer wherein the first elastomeric layer is in contact with the second conductive layer.

6. A method of manufacturing a device comprising:
applying a first elastomeric polymer layer on a substrate,
applying a conductive layer on top of the first elastomeric polymer,
applying a second elastomeric polymer layer on top of the conductive layer such that the conductive layer has a surface in contact with the first elastomeric polymer layer and the second elastomeric polymer layer adjacent to the conductive layer and opposite the first elastomeric polymer layer;
and removing the first elastomeric polymer layer, the conductive polymer layer and the second elastomeric polymer layer together from the substrate.

7. The method of manufacturing a device of claim 6, further comprising preparing the substrate including a micropattern.

8. A method of manufacturing a device of claim 6, wherein the elastomeric polymer is a silicone.
